(19) United States
(12) Patent Application Publication
(10) Pub. No.: US 2016/0095776 A1
(43) Pub. Date: Apr. 7, 2016

(54) Leg Support Device

(71) Applicants: Stan Batiste, Granite Bay, CA (US); Maryann Batiste, Granite Bay, CA (US); Daniel Batiste, Granite Bay, CA (US)

(72) Inventors: Stan Batiste, Granite Bay, CA (US); Maryann Batiste, Granite Bay, CA (US); Daniel Batiste, Granite Bay, CA (US)

(21) Appl. No.: 14/875,541

(22) Filed: Oct. 5, 2015

Related U.S. Application Data
(60) Provisional application No. 62/059,803, filed on Oct. 3, 2014.

(51) Int. Cl. A61G 7/075; A47C 20/00

(52) U.S. Cl. CPC A61G 7/0755; A47C 20/021

(57) ABSTRACT

A leg elevating device is provided that is formed from foam, an air bladder, or supportive sheets of material with straps or supports. The device elevates a user's legs when laying down such that the device has a front, a back, a first side and a second side. The device has a bottom surface having and a top surface located above the bottom surface, the top surface extending upward from a front edge, and two side edges toward to form a curved shaped. The one or more apexes are located above a back edge or above a middle of the bottom surface. The top surface ends at the back of the support material at a top surface back edge. Depending on the configuration a back surface connects to the back edge of the bottom surface, and extends upward to connect to the back of the top surface.

This application claims priority to and the benefit of U.S. Provisional Patent Application No. 62/059,803 filed on Oct. 3, 2014.

### BACKGROUND OF THE INVENTION

1. Field of Invention

The present invention relates to leg support device and in particular a leg support device for improving the hemodynamic conditions of a patient's venous system to improve vein health.

2. Background

Two vascular systems exist in the human body; the arteries and the veins. The arteries carry blood under high pressure that is supplied by the heart to the body's tissues. The blood provides nutrients and oxygen to the tissues through the branching of the arteries into the capillaries. This journey through the tissues creates resistance decreasing the flow rate and pressure of the blood which then returns to the heart through the venous system. The veins are thin walled with an overall capacity larger than that of the arteries as the same amount of blood must return to the heart at a slower velocity. Because the pressure is less, the veins have less tissue in their walls than the arteries which makes them less able to control the inner diameter when increased pressure exists. In addition, the veins have less ability to rebuild and repair when increased pressure is present for large periods of time.

As humans age, the veins continue to become less elastic and progressively become thinner with less reparative mechanisms. The physical manifestation of chronic venous pressure manifests itself cosmetically as varicose vein which are visible as projecting beyond the normal plane of the dermis with visible dark colors, which is apparent as the transparent appearance of the thin walls and the contained deoxygenated blood returning to the heart. This problem can also have health implications when the dilated vein allows for stasis of blood flow or are injured through trauma or long duration increased pressure. These factors, either alone or together, can cause an inflammatory reaction and thrombosis of the veins resulting in phlebitis. This invention creates an environment that decrease the pressure within the veins over extended lengths of time to help alleviate the problems of varicose vein formation and venous inflammation.

There are currently numerous methods that attempt to decrease varicose vein formation by either taking away the pressure inside of the dilated vein or supporting the outer walls. The most common method of supporting the outer walls of the vein is by using a wrap or stocking. Generally, these are made out of an elastic material and create a gentle, diffuse pressure on the dermal surface which transfers pressure to the wall of the veins. This pressure opposes the inner luminal pressures from the venous blood and provides less capacitance and less venous blood volume. These conditions allow the blood to travel faster through the veins eliminating areas of stasis and protect the walls from stretching from the expansion. Decreasing the inner pressure of the veins is the second method of decreasing varicose vein formation and can be done through surgical means or by changing pressure gradients through improved positioning as in leg elevation. Surgery utilizes methods of ligating varicose veins directly or rerouting flow through ligation or clotting of tributary veins to divert flow decreasing pressure. The second means of changing inner pressure is that of decreasing the relative position on the involved limb with respect to the position of one's heart. For example, if you elevate your limb above your heart the venous pressure will decrease in proportion to the height that the limb is elevated. This elevation results in almost instantaneous pressure decrease which can be negative relative to the heart pressure (right atrial) where the venous blood enters the heart.

Currently there are several means to elevate limbs above the normal position where ones feet touch the ground. Existing commercial means are those of foam blocks to provide elevation. The current designs are made for the home or office and can be used either while sitting or lying down. These designs are common in that there is a block of foam or padded material which allows the user to engage the foam block to elevate the limbs by placing the limb on the foam block.

These designs however are difficult to sleep with given the configuration that is used to maintain ones elevated leg position. As the length of time that a limb is elevated increases, the length of time high pressures are exerted on the veins is lessened, improving the overall health of the vein. Therefore, it is desirable to have a means that one can sleep comfortably while maintaining the limb elevated position.

### SUMMARY

To overcome the drawbacks of the prior art and provide additional benefits, a leg elevating device is provided that may be configured in different ways to provide the benefits disclosed herein. In one embodiment a support material sheet having a generally flat first side is provided which has a curved second side that connects at both ends to the generally flat first side. Above the support material sheet is a top sheet having a shape generally similar to the support material sheet, but capable of curving upward away from the support material to form an upwardly arching top surface having sufficient strength to support a user's legs. A first strap having a first end and a second end is also part of the device. The first end connected to the second side near the first side and the second end of the first strap connected to a first side of an adjustable buckle. A second strap has a first end and a second end such that the first end connects to the second side near the first side and the second end of the second strap connects to a second side of the adjustable buckle. The adjustable buckle has a first side and a second side that is configured to connectively and releasably connect to the straps to adjust a curvature of the upwardly arching top sheet which forms the leg elevating device by changing the distance between the first end of the first strap and the first end of the second strap.

In one or more embodiments, the device includes padding covering at least a portion of the top surface. The buckle may be adjustable to adjust the position on the strap to which it is attached. In one configuration, the top sheet is formed from flexible plastic. The top sheet may have a thickness which varies to thereby establish the upwardly arching top surface as having less arc at a top portion of the top sheet. The support material sheet may connect to the top sheet along the curved sides.

Also disclosed is a leg elevating device comprising a pre-shaped bladder defining an inner air chamber. The pre-shaped bladder has a generally flat bottom surface, a generally arching upper surface that opposes the bottom surface, and a back surface extending between the arching upper surface. An air valve is configured to selectively allow airflow into and out of the bladder to inflate and deflate the batter, the inflated state of the bladder filling the inner air chamber with air to extend the arching upper surface from the generally flat bottom.

This device may be configured such that the bottom surface is defined by a front edge and curved first side edge and a curved second side edge. The first side edge will connect to a generally linear back edge. The top surface is defined by a front edge that connects to the front edge of the bottom surface and the side edges connect to the first side edge and second side edge of the bottom. A generally linear back top surface edge connects to the bottom surface back edge. Furthermore, the back surface being generally flat and having an arching top edge that connects to the top surface and a generally flat defined by a front edge that is curved and a back edge that is linear and connects to the linear back edge of the bottom surface.

In one embodiment, the bottom surface is configured with gripping material to reduce movement of the bottom surface relative to a support surface which supports the bottom surface. The device may further include one or more support structures within the bladder. In one embodiment, the device also includes a layer of foam on the upper surface of the bladder. In one configuration, the device may also include an automated inflation and deflation device configured to inflate and deflate the bladder based on time schedule. The bladder may include straps, Velcro, or other securing means on or connected to the bottom surface of the bladder to secure the bladder to a generally horizontal surface.

In another embodiment, a leg elevating device is provided that includes a support material, such as foam, configured to support a user's legs in an elevated position when the user is laying down. The support material has a front, a back, a first side and a second side that defines the following outer shape. A bottom surface having a front edge, a first side edge, a second side edge and a back edge. A top surface located above the bottom surface such that the top surface extends upward from the front edge, the first side edge, and the second side toward one or more apexes to form a curved shape. The one or more apexes are located above a center of the back edge or above a middle of the bottom surface and the top surface ends at the back of the support material at a top surface back edge. A back surface is also part of the device to complete the shape. The back surface has a bottom edge, connected to the back edge of the bottom surface, and a top edge. The back surface extends upward from back edge of the bottom surface to the back of the top surface such that the top edge of the back surface connects to the top surface back edge.

A gripping material may be located on the bottom surface. Gripping material may be located on the top surface. The top surface may include one or more apexes separated by valleys. In one configuration, a portion of the top surface is flat.

### DESCRIPTION OF THE FIGURES

The components in the figures are not necessarily to scale, emphasis instead being placed upon illustrating the principles of the invention. In the figures, like reference numerals designate corresponding parts throughout the different views.

FIGS. 1 and 2 illustrate a foam block 100 shaped with generally abrupt side edges.

FIG. 3 illustrates a leg support device that incorporates a continuous angled contour leading to a raised apex.

FIG. 4 illustrates an example environment of use.

FIG. 5 illustrates an example environment of use with a user lying in a supine position.

FIG. 6 illustrates an example environment of use with a user lying in a prone position.

FIG. 7 illustrates an alternative embodiment of the leg support device with a generally flat apex area.

FIGS. 8A, 8B and 8C illustrate an embodiment of the leg support device including a tensioned strap used to create the arc in the top surface.

FIGS. 9A, 9B and 9C illustrate a leg support device formed from an air bladder.

FIGS. 10A and 10B illustrate leg support device having stability bars.

FIGS. 11A, 11B and 11C illustrate an exemplary leg support device with a hinged broad support panel.

### DESCRIPTION OF THE INVENTION

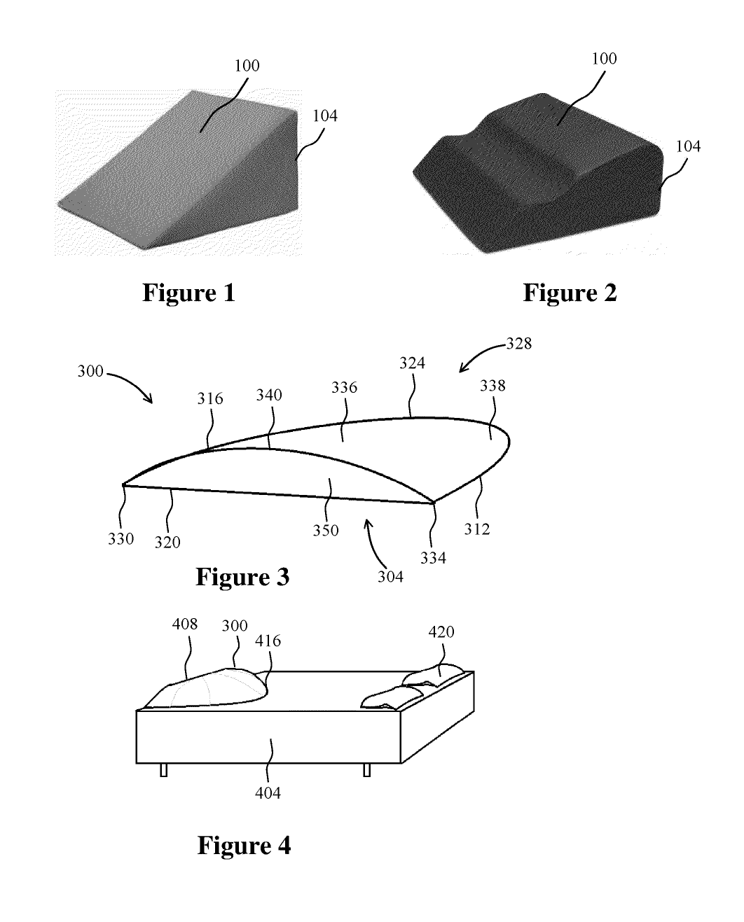

Generally, the longer the leg elevation or compression techniques are applied the better the results. For compression, people can wear compression stocking around all day and even at night which have shown to work well and are easily tolerated. Leg elevation however is much more difficult to perform on a sustained basis as people are generally busy all day it is difficult for most to keep one's leg elevated sufficiently. If possible however vein elevation is effective as it takes the pressure off of the veins and allows them to contract and repair from hours of increased pressures. There are currently many types of devices to help maintain leg elevation providing comfortable means of raising ones legs above the heart if possible. These current devices are good for short times of leg elevation but do not address the problem of leg elevation for the longest duration when one is asleep. The most common means of leg elevation is that of a cushion that is formed by creating a rise which is inclined in shape (FIG. 1) or step shaped (FIG. 2). These are place under the legs and are used with the person lying down. Different shapes are used for the two different positions; supine and prone. Although they can be used during sleeping the current designs are not made for both positions. In addition, the edges of the current designs are all vertical step-offs which must be overcome when a change of position is required. Therefore the current designs that are used for limb elevation are not generally designed for overnight sleeping positions which are the best for long term, low pressure vein care.

The invention is a new type of limb elevation cushion which creates a comfortable means of raising ones extremity above the heart while lying down to decrease the hemostatic pressures inside of the veins ultimately leading to improved vein health and decrease development of spider and varicose veins. The invention overcomes the current problems of keeping ones limb elevated while sleeping in various positions and allows the user to comfortably change in position while sleeping with limbs elevated.

Until now pillows and cushions used for elevation had either steep inclines of a step type configuration for elevation with the sides of the apparatus at a ninety degree step-off as shown in FIGS. 1 and 2. As shown in FIGS. 1 and 2 a foam block 100 is shaped with generally abrupt side edges 104 causing these prior art designs to suffer from the drawbacks of the prior art as discussed here.

Although functional in a stationary position the steep edge make it so the user must stay in position so not to fall off of the edge. This also limits one's ability to sleep comfortably and change position without a concentrated effort to stay on the cushion/pillow. As a further drawback, the unchangeable size of the foam support 100 leads to difficulty in storage when not in use, and normal use of sheets/blankets when in use.

The new invention allows the user to sleep in any position without the potential for falling off the cushion abruptly and allows smooth transition from one position to another and even allows for easy transfer off the device if one does not want further elevation during sleep. Additionally, others that occupy the bed will not be met with an obstruction to moving their legs over the bed surface with the new invention. The new leg support design also allows for easier storage and use under blankets.

Although we describe many embodiments, the designs are similar in that there is a smooth transition from the normal bed surface with an incline to the raised surface of the improved venous cushion. As shown in FIG. 3, the design incorporates a continuous angled contour figure leading to a raised apex (which may be curved along the top surface or generally flat) within the most superior portion figure. This provides the gentle slope for easy transition and limb mobility while allowing the user to transition on and off the cushion with little abrupt change. As shown, the leg support 300 includes a bottom surface 304 (not visible) having a back edge 320, a first side 31, and a second side 316 and a front side 324. The front edge 324 is at the front 328 of the leg support. The bottom surface may be generally planar. The bottom surface includes the back edge 320 that has a first bottom corner 334 and a second bottom corner 330.

Extending upward from the bottom surface is a top surface 336 that slopes gradually upward in a curved side area 338 of the top surface. The top surface area 336 may be generally flat curved depending the design of the particular embodiment. The top surface 336 is connected to the bottom surface 304 along the front edge 324 and the first and second side edges 312, 316. The connection may be any type connection depending on the configuration of the leg support. The top surface 336 is arced upward to form a sloped arc upward to a top back edge 336 of the top surface. An apex of the top back edge 340 of the top surface 336 may be flat or the slope of the sides 338 may continue to the top surface back edge.

A back surface 350 is at the back of the leg support 300. In this embodiment the back surface 350 is generally flat and extends between the back edge 320 of the bottom surface and the back edge 340 of the top surface 336. In other embodiment the back surface 350 may be other than flat.

As shown, the leg support 300 has a sloping sides which rise to a top area 340, 336 defined by the top back edge and top surface. The leg support 300 provides a non-abrupt edge for the user thereby allowing the user to roll on or off of the support and preventing a jarring leg drop off if their legs falls off the leg support. It also allows the user to vary the elevation of the leg by moving leg to the side, which moves the leg to a lower elevation due to the sloping nature of the side area 338.

In the configuration of FIG. 3 and all different possible means for building the leg support, the upper portion of the top surface may vary and be any of the following configurations including generally flat, curved, wavy such as with multiple waves or dips, or in the shape of gently sloping W to cradle the feet, or with waves or dips. The upper surface may also have one or more dips, ridges or depressions to aid in securing of the feet or legs during sleep to encourage the legs to be maintained in a desired position on the support. Memory foam may be used to on the top surface to form user created depressions which support and maintain the user's legs without pressure points.

The leg support 300 may be adjustable by the user as discussed below in connection with different embodiment. The height of the leg support may vary based on how the user configures the adjustable leg support to suit the user or the advice of the doctor. Likewise the width and length of the leg support may be adjusted or varied during manufacturing.

FIG. 4 illustrates an example environment of use. In this embodiment, the leg support pillow 300 is on a bed 404 having pillows 420 at a top or front end of the bed. At the opposite end is the leg support 300 with the front of the leg support device facing or closest to the pillows 420. In this embodiment, the leg support 300 is shown where the apex is a long flat plane 408 which is lengthened in this configuration to span the length of the bed. In other embodiment, the leg support may only span a portion of the bed 404. The back edge (not visible) of the leg support device faces the furthermost end of the bed 404.

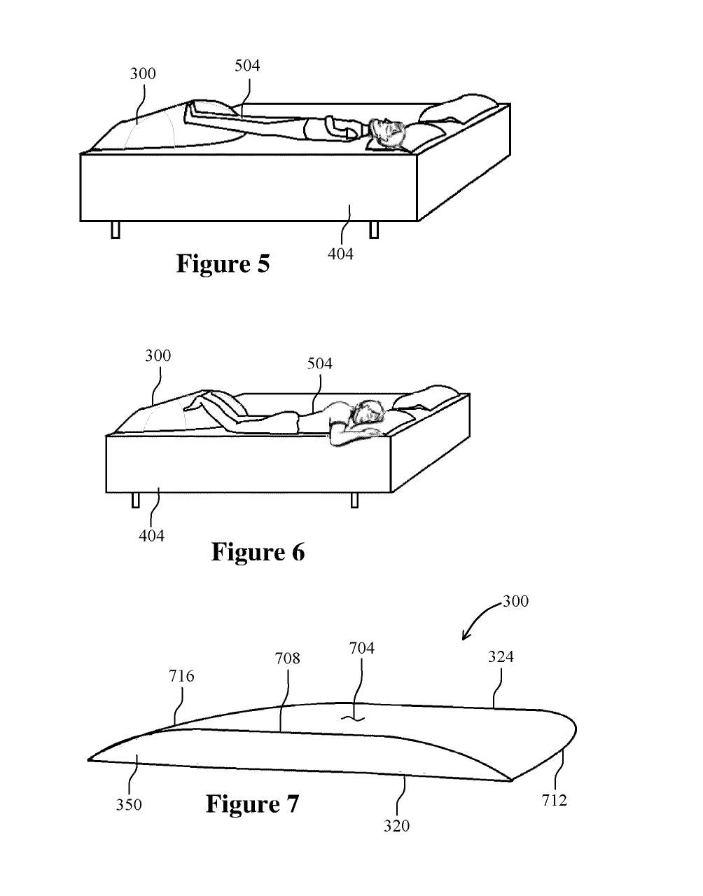

FIG. 5 illustrates an example environment of use with a user lying in a supine position. As shown, a user 504 has their legs supported by the leg support device 300 while resting or sleeping on a bed 404.

FIG. 6 illustrates an example environment of use with a user lying in a prone position. As shown, a user 504 has their legs supported by the leg support device 300 while resting or sleeping on a bed 404.

FIG. 7 illustrates an alternative embodiment of the leg support device with a generally flat apex area. As shown the leg support device 300 includes the back bottom edge 320 that opposes the front bottom edge 324. Connecting the front bottom edge 324 and the back bottom edge 320 are a first side edge 712 and second side edge 716. A top surface 704 extends from the front bottom edge and sides 712, 716 to the top back edge 708. The back surface 350 extends between the top back edge and the bottom back edge. In this embodiment the top surface 704 is general flat, as opposed to the generally curved top area of FIG. 3. In addition, the sides 712, 716 are less curved as compared to the embodiment of FIG. 3. These variations expand the possible shapes which are possible for the leg support device. If cushion if made out of a solid piece of material such as polyurethane, it may be covered by a fabric such as cotton as done with a standard pillow case.

There are numerous ways to create the above mentioned 180 degree gentle sloping vein cushion, several are shown and described below. Numerous embodiments of the designs are easily convertible into a flat surface so that they are not noticeable under the user's bed sheets when not in use.

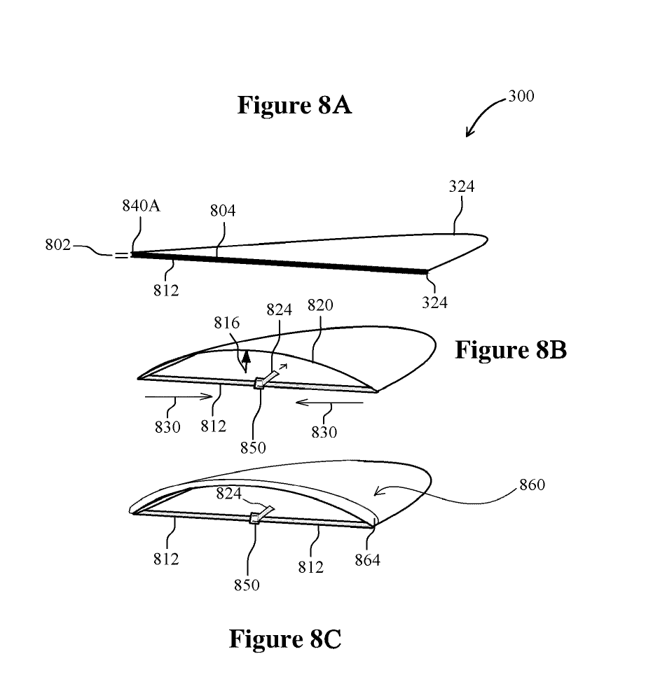

FIGS. 8A, 8B and 8C illustrate an embodiment of the legs support device including a tensioned strap used to create the arc in the top surface. The leg support device 300 is also configured with a curvature that generates an arch shape. The curvature may be adjusted or removed entirely. One or more adjustment straps 812 are connected to back corners 840A, 840B and extend to a center area of the back bottom edge 804. The straps 812 have connectors or buckles 850 which allow the straps to be adjusted in length, which in turn adjusts the curvature of the curve 820. In this manner, the curvature 820 may be adjusted to match a user's desired leg height and slope and provide a desired level of support or lifting. As shown in FIG. 8A, the strap 812 and buckle 850 combination may be loosened allowing the height 802 of the leg support to be minimized, enabling easy storage in a closet or on/under the bed.

As shown in FIGS. 8B and 8C, the strap end 824 may be pulled through the buckle 850 to shorten the distance between the bottom ends 840A, 840B to thereby induce a curvature in the top edge 820 of the top surface. By adjusting the strap 812, 824 relative to the buckle 850 the arc in the top surface is adjusted. This design may utilize a sheet of material such as ABS plastic for the top surface that can be bent into the desired shape as in this example with an adjustment strap 812. As the strap 812 is tightened the convex shape is developed and with securing of the strap the shape is maintained.

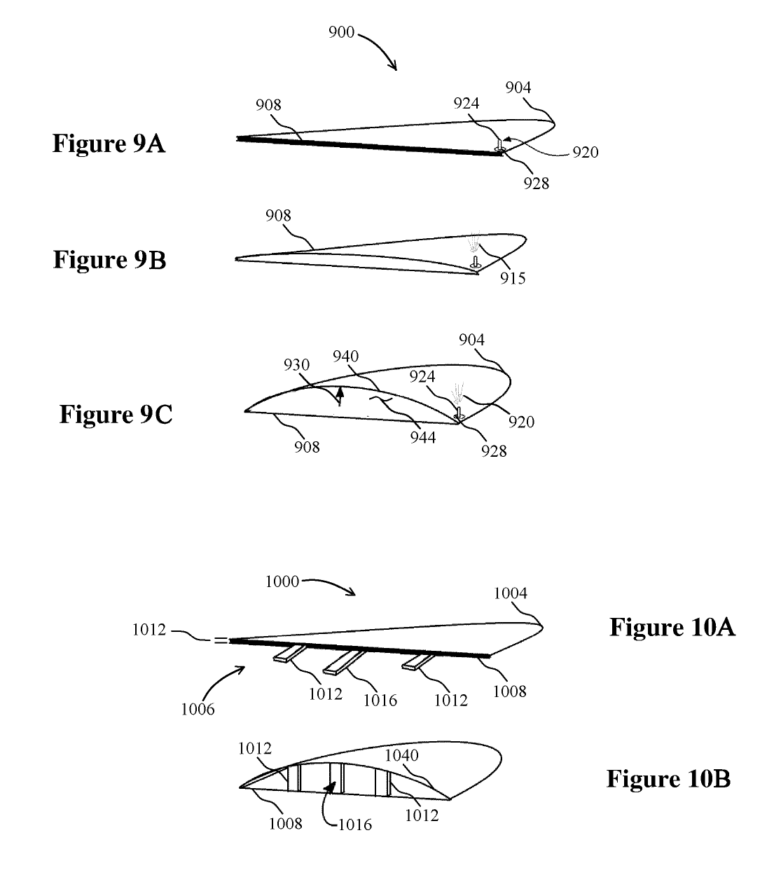

FIGS. 9A, 9B and 9C illustrate a leg support device formed from an air bladder that, when inflated has the desired contour of the gentle degree slope. When deflated it is easily hidden below the bed sheets. The bladder 900 has a front 904 and back 908 to form a shape as shown and discussed above. In this embodiment the bladder 900 includes one or more air paths 920 which may be selectively opened or closed using a valve 924. The valve 928 is secured, such as by glue or heat welding to the bladder 900. This enables the user to selectively inflate or deflate the bladder using air 915 or other gas for storage or to adjust the height, sink-in of the legs, and curvature to suit the doctor's recommendations. When inflated, the back top edge 940 rises to form an arc and expand the back surface 944 by lifting the back top edge 940 upward 930 as shown.

FIGS. 10A and 10B illustrate leg support device having stability bars that can lay flat when not in use and then when needed are positioned such that they lie beneath the material elevating it to form the gentle curve. This is but one possible configuration and embodiment equipped with stability bars. In this embodiment the leg support device 100 includes a front 1004 and opposing back section 1006 and a flexible but supportive top surface. The supports 1012 and 1016 are shown in FIG. 10A as being in the flat or down position to establish the height 1012 of the leg support as minimal or generally flat. The supports 1012 are a different height than the center support 1016 thereby causing the top surface and top surface back edge 1040 to be curved or arced with a sloping upward arc as shown. FIG. 10B illustrates the leg support defined in the raised position by moving the supports 1012, 1016 upward to lift the top surface back edge 1040.

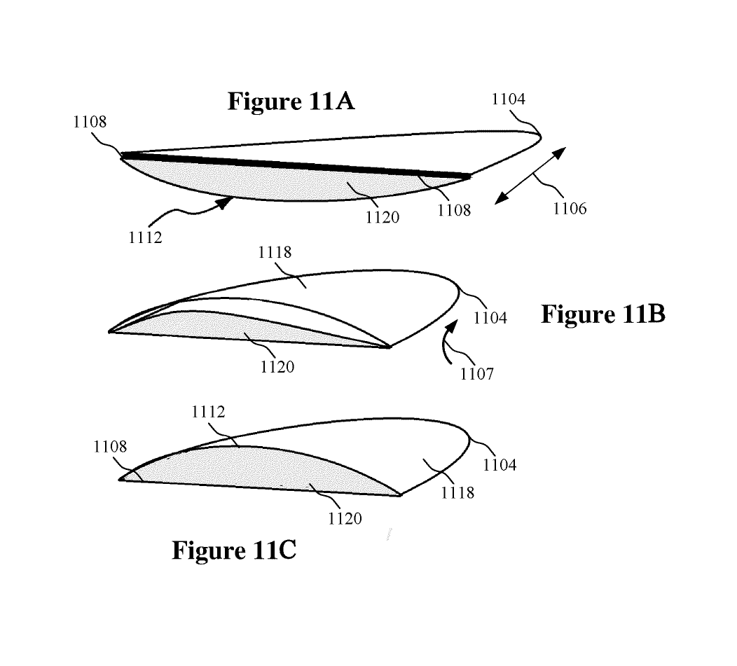

FIGS. 11A, 11B and 11C illustrates exemplary leg support device with a hinged support panel that lies flat when not in use and then when elevated and placed under the limb support creates the desired curvature and gentle slope for limb elevation. As shown in FIG. 11A, the leg support device is generally flat in a single plane 1106 shown by the arrow such that the hinged support panel 1120 is extended with the top edge 1112 exposed or it could be folded into the interior of the leg support. The support panel attaches to the bottom support surface (now shown) at a hinge 1108 or other flexible interface. It can be folded flat as shown in FIG. 11A or folded upward in the progression of FIGS. 11B and 11C in the rotational direction 1107 to cause the top edge of the support panel to connect to the back edge of the top surface 1118. The connection between the top surface 1118 may be any type connection including clips, grooves, Velcro, or any other known or future developed connection method and means. As shown in FIG. 11C, the support panel 1120 is folded upward to support the top edge of the top surface 1118 to form the arch top surface. The top surface 1118 may be formed from a stiff or pre-curved material to provide sufficient support for a user's legs even if only supported at the back support panel. This is but one possible design configuration that uses a folding or hinged panel for support and it is contemplated that additional inner supports may also be provided to provide additional interior support.

What is claimed is:

1. A leg elevating device comprising:
a support material sheet having a generally flat first side, a curved second side which connects at both ends to the generally flat first side;
a top sheet having a shape generally similar to the support material sheet, but capable of curving upward away from the support material to form an upwardly arching top surface having sufficient strength to support a user's legs;
a first strap having a first end and a second end, the first end connected to the second side near the first side and the second end of the first strap connected to a first side of an adjustable buckle;
a second strap having a first end and a second end, the first end connected to the second side near the first side and the second end of the second strap connected to a second side of the adjustable buckle; and
the adjustable buckle having a first side and a second side that is configured to connectively and releasably connect to the straps to adjust a curvature of the upwardly arcing top sheet which forms the leg elevating device by changing the distance between the first end of the first strap and the first end of the second strap.

2. The device of claim 1, further comprising padding covering at least a portion of the top surface.

3. The device of claim 1, wherein the buckle is adjustable to adjust the position of a buckle position on the strap to which it is attached.

4. The device of claim 1, wherein the top sheet is formed from flexible plastic.

5. The device of claim 1, wherein the top sheet has a thickness which varies to thereby establish the upwardly arcing top surface as having less arc at a top portion of the top sheet.

6. The device of claim 1, wherein the support material sheet connects to the top sheet along the curved sides.

7. A leg elevating device comprising:
a pre-shaped bladder defining an inner air chamber, the pre-shaped bladder having a generally flat bottom surface, a generally arcing upper surface that opposes the bottom surface, and a back surface extending between the arcing upper surface; and
an air valve configured selectively allow airflow into and out of the bladder to inflate and deflate the batter, the inflated state of the bladder filling the inner air chamber with air to extend the arcing upper surface from the generally flat bottom.

8. The device of claim 6 wherein:
the bottom surface is defined by a front edge and curved first side edge and a curved second side edge, the first side edge connects to a generally linear back edge;
the top surface is defined by a front edge that connects to the front edge of the bottom surface, side edges that connect to the first side edge and second side edges of the bottom, and a generally linear back top surface edge that connects to the bottom surface back edge; and
the back surface being generally flat and having an arching top edge that connects to the top surface and a generally flat defined by a front edge that is curved and a back edge that is linear and connects to the linear back edge of the bottom surface.

9. The device of claim 6, wherein the bottom surface is configured with gripping material to reduce movement of the bottom surface relative to a support surface which supports the bottom surface.

10. The device of claim 6 further including one or more support structures within the bladder.

11. The device of claim 6 further comprising a layer of foam on the upper surface of the bladder.

12. The device of claim 6 further comprising an automated inflation and deflation device configured to inflate and deflate the bladder based on time schedule.

13. The bladder of claim 2, further comprising one or more straps, Velcro, or other securing means on or connected to the bottom surface of the bladder to secure the bladder to a generally horizontal surface.

14. A leg elevating device comprising:
a support material configured to support a user's legs in an elevated position when the user is laying down, the support material having a front, a back, a first side and a second side defining the following outer shape:
a bottom surface having a front edge, a first side edge, a second side edge and a back edge;
a top surface located above the bottom surface, the top surface extending upward from the front edge, the first side edge, and the second side toward one or more apexes to form a curved shaped, the one or more apexes located above a center of the back edge or above a middle of the bottom surface, the top surface ending at the back of the support material at a top surface back edge; and
a back surface having a bottom edge, connected to the back edge of the bottom surface, and a top edge, the back surface extending upward from back edge of the bottom surface to the back of the top surface, the top edge of the back surface connected to the top surface back edge.

15. The device of claim 14 wherein the support material is foam.

16. The device of claim 14 further comprising gripping material located on the bottom surface.

17. The device of claim 14 further comprising gripping material located on the top surface.

18. The device of claim 14 wherein the top surface includes one or more apexes separated by valleys.

19. The device of claim 14 wherein a portion of the top surface is flat.
